(19) United States
(12) Patent Application Publication
(10) Pub. No.: US 2024/0104599 A1
(43) Pub. Date: Mar. 28, 2024

(54) SYSTEMS AND METHODS FOR ALLOCATING BLOCKCHAIN INCENTIVES

(71) Applicant: Capital One Services, LLC, McLean, VA (US)

(72) Inventors: Samuel Rapowitz, Roswell, GA (US); Kevin Osborn, Newton Highlands, MA (US); Xiaoguang Zhu, New York, NY (US)

(21) Appl. No.: 17/955,452

(22) Filed: Sep. 28, 2022

(51) Int. Cl. G06Q 30/02

(52) U.S. Cl. CPC G06Q 30/0225

(57) ABSTRACT

A system may verify a plurality of electronic utility data records to determine when each of the plurality of electronic utility data records is authentic. The system may determine a proportion of sustainable energy utilization data in each of the verified plurality of electronic utility data records. The system may assign a weighting factor to the determined proportion of the sustainable energy utilization data for each the verified plurality of electronic utility data records. The system may generate a sustainable energy score from the assigned weighting factor for each of the verified plurality of electronic utility data records. The system may rank each of the verified plurality of electronic utility data records by the generated sustainable energy score. The system may determine one or more of the ranked plurality of electronic utility data records above a predefined threshold level, and may provide incentives to computing device(s) associated with such records.

### FIELD

The present disclosure relates generally to systems and methods for allocating blockchain incentives to incentivize environment-friendly blockchain transaction validation.

### BACKGROUND

Current developing technologies are increasingly distributed, rather than centralized, with distributed ledgers, such as blockchain, peer-to-peer interaction models, and micro-transactions, replacing or complementing traditional models that involve centralized authorities or intermediaries. Operations on blockchains, such as ones using cryptocurrency, increasingly require energy-intensive computing operations, such as calculating very large hash functions on growing chains of blocks. Systems using proof-of-work, proof-of-stake, and the like, have led to “mining” operations by which computer processing power is applied at a large scale in order to perform calculations that support collective trust in transactions that are recorded in blockchains.

As a result of these and other trends, energy consumption has become a major factor in utilization of computing resources, such that energy resources and computing resources (or simply “energy and compute”) have begun to converge from various standpoints, such as requisitioning, purchasing, provisioning, configuration, and management of inputs, activities, outputs, and the like. Accordingly, there is a need to encourage use of sustainable energy for performing such complex computations.

### SUMMARY

Examples of the present disclosure provide solutions to the above-described issues associated with providing energy-efficient blockchain mining. The present disclosure describes systems and methods that provide conservation weighting to incentivize environment-friendly blockchain transaction validation. The present disclosure provides a system for providing energy-efficient blockchain mining. The system may include one or more processors; and memory in communication with the one or more processors and storing instructions that, when executed by the one or more processors, are configured to cause the system to provide an energy-efficient blockchain mining. The system may receive a plurality of electronic utility data records associated with use of one or more utilities by one or more computing devices for mining blockchain. The system may analyze each of the received plurality of electronic utility data records to determine when the received plurality of electronic utility data records is complete, wherein each of the received plurality of electronic utility data records is complete when each of the received plurality of electronic utility data records comprises a predefined set of utility measuring values. The system may verify each of the analyzed plurality of electronic utility data records with a utility server to determine when each of the analyzed plurality of electronic utility data records is authentic upon determining that the received electronic utility data is complete. In verifying each of the analyzed plurality of electronic utility data records, the system may connect, via a network channel, with the utility server; may identify an electronic record in the utility server associated with each of the analyzed plurality of electronic utility data records based on at least a unique identifying value in each of the analyzed plurality of electronic utility data records; and may scan the identified electronic record for each of the analyzed plurality of electronic utility data records and correlate the identified electronic record with the analyzed plurality of electronic utility data records. The system may assign a weighting factor for each of the verified plurality of electronic utility data records when the analyzed plurality of electronic utility data records is determined to be authentic. The system may generate a sustainable energy score from the assigned weighting factor for each of the verified plurality of electronic utility data records. The system may rank each of the verified plurality of electronic utility data records by the generated sustainable energy score. The system may determine that one or more of the ranked plurality of electronic utility data records are above a predefined threshold level. The system may provide one or more incentives to the one or more computing devices associated with the determined one or more of the ranked plurality of electronic utility data records above the predefined threshold level.

The present disclosure provides a method for providing energy-efficient blockchain mining. The method may include receiving a plurality of electronic utility data records associated with use of one or more utilities by one or more computing devices for mining blockchain. The method may include analyzing each of the received plurality of electronic utility data records to determine when the received plurality of electronic utility data records is complete, wherein each of the received plurality of electronic utility data records is complete when each of the received plurality of electronic utility data records comprises a predefined set of utility measuring values. The method may include verifying each of the analyzed plurality of electronic utility data records with a utility server to determine when each of the analyzed plurality of electronic utility data records is authentic upon determining that the received electronic utility data is complete, wherein the verifying further comprises: connecting, via a network channel, with the utility server; identifying an electronic record in the utility server associated with each of the analyzed plurality of electronic utility data records based on at least a unique identifying value in each of the analyzed plurality of electronic utility data records; and scanning the identified electronic record for each of the analyzed plurality of electronic utility data records and correlating the identified electronic record with the analyzed plurality of electronic utility data records. The method may include assigning a weighting factor for each of the verified plurality of electronic utility data records when the analyzed plurality of electronic utility data records is determined to be authentic. The method may include generating a sustainable energy score from the assigned weighting factor for each of the verified plurality of electronic utility data records. The method may include ranking each of the verified plurality of electronic utility data records by the generated sustainable energy score. The method may include determining one or more of the ranked plurality of electronic utility data records above a predefined threshold level. The method may include providing one or more incentives to the one or more computing devices associated with the determined one or more of the ranked plurality of electronic utility data records above the predefined threshold level.

The present disclosure provides a method for providing energy-efficient blockchain mining. The method may include verifying a plurality of received electronic utility data records with a utility server in real-time to determine when each of the plurality of received electronic utility data records is authentic, wherein the plurality of received electronic utility data records are associated with use of one or more utilities by one or more computing devices for mining blockchain. The method may include determining a proportion of sustainable energy utilization data in each of the verified plurality of electronic utility data records determined to be authentic. The method may include assigning a weighting factor to the determined proportion of the sustainable energy utilization data for each of the verified plurality of electronic utility data records determined to be authentic. The method may include generating a sustainable energy score from the assigned weighting factor for each of the verified plurality of electronic utility data records. The method may include ranking each of the verified plurality of electronic utility data records by the generated sustainable energy score. The method may include determining one or more of the ranked plurality of electronic utility data records above a predefined threshold level. The method may include providing one or more incentives to the one or more computing devices associated with the determined one or more of the ranked plurality of electronic utility data records above the predefined threshold level.

These and other aspects of the present disclosure are described in the Detailed Description below and the accompanying figures. Other aspects and features of examples of the present disclosure will become apparent to those of ordinary skill in the art upon reviewing the following description of specific, exemplary examples of the present invention in concert with the figures. While features of the present disclosure can be discussed relative to certain examples and figures, all examples of the present disclosure can include one or more of the features discussed herein. Further, while one or more examples can be discussed as having certain advantageous features, one or more of such features can also be used with the various examples of the invention discussed herein. In similar fashion, while exemplary examples can be discussed below as device, system, or method examples, it is to be understood that such exemplary examples can be implemented in various devices, systems, and methods of the present invention.

### BRIEF DESCRIPTION OF THE DRAWINGS

The accompanying drawings, which are incorporated in and constitute a part of this specification, illustrate multiple examples of the presently disclosed subject matter and serve to explain the principles of the presently disclosed subject matter. The drawings are not intended to limit the scope of the presently disclosed subject matter in any manner. In the drawings:

FIG. 1 is a diagram of an example system environment that can be used to implement one or more examples of the present disclosure;

FIG. 2 is a component diagram of an example user device, according to one or more examples of the present disclosure; and

FIG. 3 is a flowchart of a method for providing conservation weighting to incentivize environment-friendly blockchain transaction validation, according to one or more examples of the present disclosure.

### DETAILED DESCRIPTION

Examples of the present disclosure generally include systems and methods for providing conservation weighting to incentivize environment-friendly blockchain transaction validation. By using the techniques illustrated below, the disclosed technology may encourage blockchain mining using sustainable energy sources. For example, the disclosed technology provides incentives or rewards for certain user devices that use sustainable energy sources, thereby reducing the carbon emission from mining blockchain.

Reference will now be made in detail to exemplary examples of the disclosed technology, examples of which are illustrated in the accompanying drawings and disclosed herein. Wherever convenient, the same reference numbers will be used throughout the drawings to refer to the same or like parts.

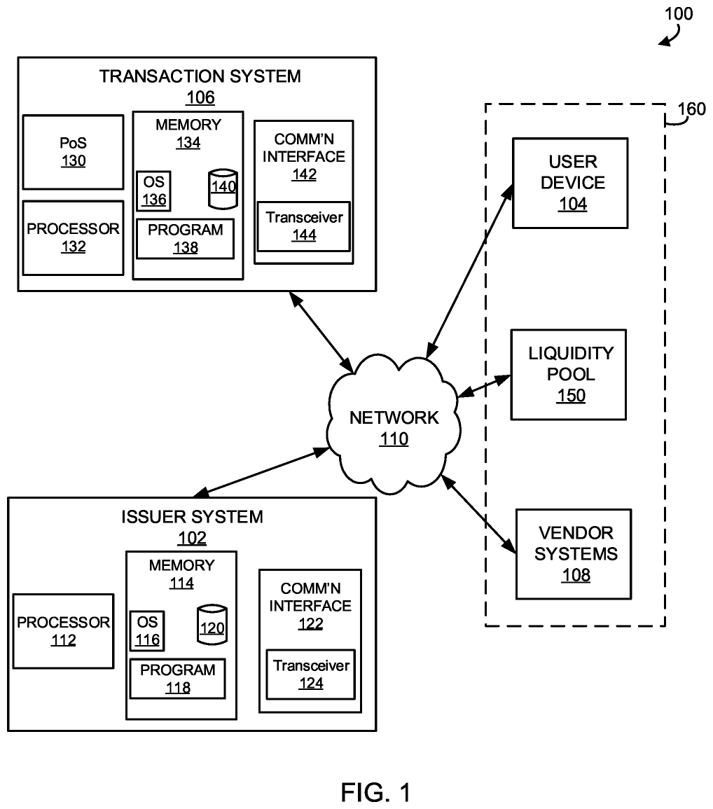

FIG. 1 is a diagram of an example system environment 100 that can be used to implement one or more examples of the present disclosure. A more detailed explanation of the components of the system environment 100 is provided below. It is beneficial, however, to provide a brief overview to describe the components of the systems and methods for providing conservation weighting to incentivize environment-friendly blockchain transaction validation. The system environment 100 can include an issuer system 102. The issuer system 102 can be associated with a financial institution that issues a credit card, manages customer accounts, and provides points for completing transactions with the credit card or another line of credit. As described above, it is contemplated that the issuer system 102 described herein can access off-chain data, including information related to transactions between (i) transaction points for credit card transactions, and (ii) off-chain vendor rewards. To this end, the issuer system 102 can operate as a decentralized oracle to provide conservation weighting to incentivize environment-friendly blockchain transaction validation within a pool (e.g., liquidity pool 150). It should be understood, however, that when reference is made herein to the issuer system 102 completing a task or process, another entity can equally perform the task or process for the issuer system 102. For example, the issuer system 102 can request third parties to facilitate the management of the liquidity pool 150 and/or operate as the decentralized oracle.

The issuer system 102 can communicate over a network 110 with a transaction system 106. The transaction system 106 can be associated with entities that provide goods or services for a fee. A customer can, for example, complete a transaction at the transaction system 106 (e.g., at a point of sale (PoS) device), and the transaction information can be relayed to the issuer system 102 for processing. After processing the transaction, the issuer system 102 can allocate a number of points to the particular transaction, as will be appreciated by those having skill in the pertinent art.

The system environment 100 can also include a user device 104. The user device 104 can be a component, or a node, of a blockchain 160. As will be appreciated by those having skill in the pertinent art, the blockchain 160 can comprise a plurality of nodes. Other nodes within the blockchain 160 environment can include one or more vendor systems 108 (such as servers of utilities companies) that assist with validating the proof of energy utilization within blockchain 160, although the vendor system(s) 108 can include any entity that wishes to add rewards to be traded for points, including but not limited to, hotels, airlines, car rental entities, or any other retail or service provider (e.g., rewards can work similar to a gift card in that the rewards can be used in lieu of flat currency).

The blockchain 160 can also include a liquidity pool 150. As described above, the liquidity pool 150 can be the repository of the points and/or rewards that can be traded in the system environment 100. The liquidity pool 150 can be data represented within one or more addresses associated with the assets (e.g., points or rewards). Addresses can comprise the final location of particular assets and asset information. For example, an address can include a particular amount of points, a particular amount of rewards, etc. The components and/or nodes of the blockchain 160 can communicate with the issuer system 102 over a wired or wireless network 110. The network 110 can, therefore, facilitate transactions being made in the blockchain 160 (e.g., trades in points, rewards, etc.) between the nodes.

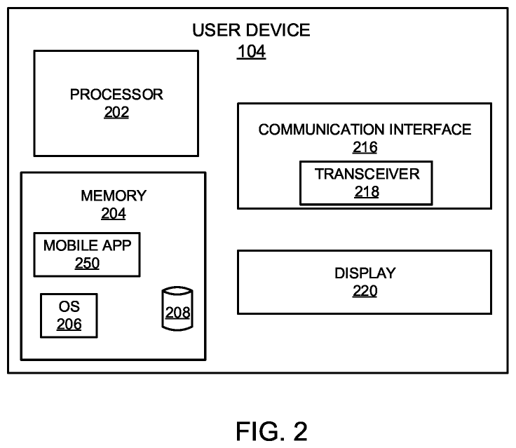

FIG. 2 is a component diagram of an example user device 104, according to the present disclosure. The device 104 can be a mobile computing device (e.g., a smart phone, tablet computer, smart wearable (e.g., a smart watch), portable laptop computer, voice command device, wearable augmented reality device, or other mobile computing device) or a stationary device (e.g., a desktop computer). The device 104 can include a processor 202, and a memory 204 including an operating system (“OS”) 206, one or more programs (e.g., a mobile application 250), and/or data storage 208. The device 104 can also include a communication interface 216 that includes a transceiver 218. The communication interface 216 and/or transceiver 218 can be used to transmit and/or receive the data described throughout this disclosure, including, for example, the requests to provide conservation weighting to incentivize environment-friendly blockchain transaction validation. The user device 104 can include a display 220, that can provide visual representation of the applications (e.g., mobile application 250) and/or graphical user interfaces (GUIs) associated with those applications.

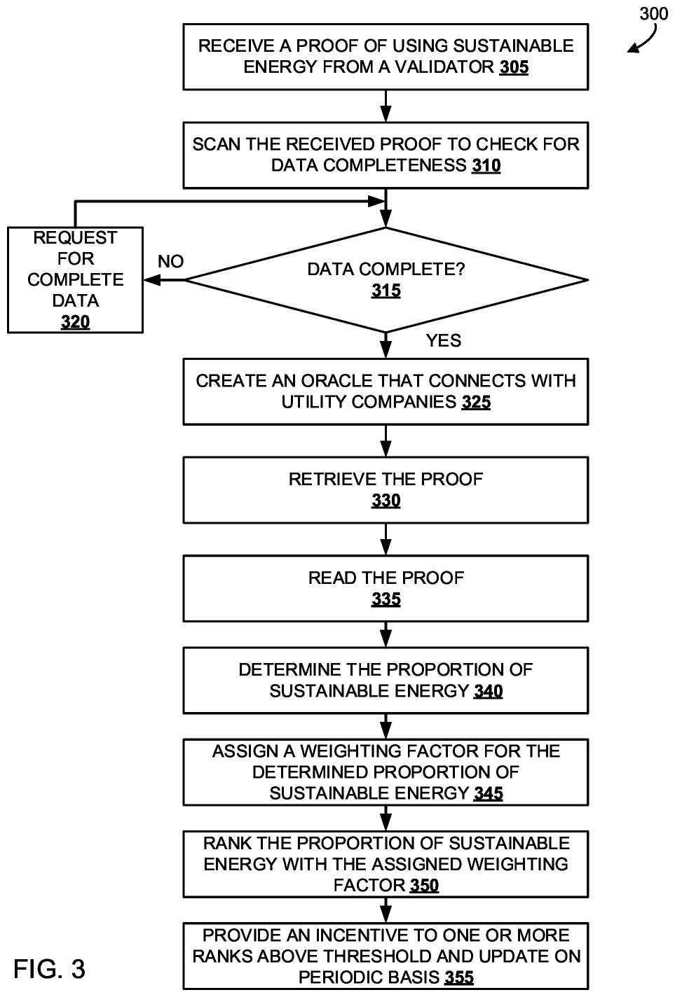

FIG. 3 is a flowchart of a method 300 for providing conservation weighting to incentivize environment-friendly blockchain transaction validation. Method 300 may be performed by one or more components of system environment 100 (e.g., issuer system 102, transaction system 106, and/or blockchain 160).

In block 305, the system (e.g., issuer system 102) may receive a proof of using sustainable energy from a user device (e.g., user device 104) for use of mining blockchain. In some embodiments, the system can receive the verification data, including proof of using sustainable energy, from one or more other devices, such as an energy utilization validator device (not shown). By way of example, the verification data of using sustainable energy can include electronic receipts of energy usage of solar panel meters data, wind power turbine utilization data, or utility bills data, although other types of proof can be received by the system. In some embodiments, blockchain mining relates to the computational work that the nodes within the blockchain 160 undertake to earn new tokens, although blockchain mining can include other types or amounts of information.

In block 310, the system (e.g., issuer system 102) may scan the received proof to check for data completeness. It should be appreciated that a variety of techniques can be used to check if the data is complete. In some embodiments, scanning relates to line-by-line parsing of the received verification data, although scanning can include other types of techniques that can be used to check for data completeness.

In block 315, the system (e.g., issuer system 102) may determine whether the verification data is complete based on the scanning performed in block 310. In some embodiments, the system may determine that the verification data is complete when all of the data fields within the received verification data include all of the relevant values in the correct format, and/or when all of the data fields within the verification data are complete. In some embodiments, however, if the system determines that at least one data field is missing from the verification data, and/or the received verification data is in an improper format, the system may determine that the received verification data is incomplete. Accordingly, when the system determines that the data is incomplete, the method may proceed to block 320, as discussed below.

In block 320, in response to determining the data is incomplete, the system (e.g., issuer system 102) may request the user device (e.g., user device 104) provide the complete verification data. The method may then proceed back to block 315, as discussed above, so that the system can again determine whether the verification data is complete.

In block 325, in response to determining the data is complete, the system (e.g., issuer system 102) may create an oracle that connects with the vendor system(s) (e.g., utility company server) 108. In some embodiments, the system may connect with one or more other devices not shown in the system environment 100 of FIG. 1 using other techniques. In some embodiments, blockchain oracles may include entities that connect blockchains to external systems, thereby enabling smart contracts to execute based upon inputs and outputs from the real world.

In block 330, the system (e.g., issuer system 102) may retrieve the energy data associated with the received verification data from the vendor system(s) 108. In some embodiments, the system may retrieve the energy data from other locations. In some embodiments, the verification data that is received in block 305 may include a unique identification number associated with the verification data, and the system may use the unique identification number to retrieve the corresponding energy data, although other techniques can be used to retrieve the energy data.

In block 335, the system (e.g., issuer system 102) may scan the retrieved energy data, and compare it with the verification data that was received in block 305, to determine whether the verification data that was provided is authentic, although the system can use other techniques to determine if the provided verification data is authentic. In some embodiments, the system may compare the data present in the energy data against the corresponding data in the received verification data to determine if there is a match. When there is an exact match, the system may determine that the received verification data is authentic. On the other hand, when there is a mismatch in at least a portion of the data that is present between the retrieved energy data and the received verification data, the system may determine that the received verification data is not authentic. In such case, the exemplary method 300 may end upon providing an error to the user device. In some embodiments, the system may also request the user device provide authentic data when there is a mismatch in the data between the retrieved energy data and the received verification data.

In block 340, the system (e.g., issuer system 102) may identify a proportion of the received verification data that is directed to use of sustainable energy. In some embodiments, sustainable energy may include solar energy, wind power energy, hydropower energy, or geothermal energy, although other types of sustainable energy could be used. By way of example, the system may scan through the received verification data line by line to search for keywords associated with sustainable energy to identify the energy utilization, although the system may use other techniques to identify the proportion of the received verification data that is directed to use of sustainable energy. For example, the system may scan the received verification data to identify one or more keywords, such as an energy meter reading from a solar panel meter. Further, the system may calculate the proportion of use of sustainable energy by dividing the proportion of the energy utilized from the sustainable energy against the total energy consumption, although other techniques can be used to identify the proportion. For example, if the received verification data includes a total of 10 units of energy utilized out of which 8 units are from the solar panel that is installed, the system may determine that 80% (proportion) of the energy used is from sustainable energy.

In block 345, the system (e.g., issuer system 102) may assign a weighting factor for the determined proportion of sustainable energy. In some embodiments, the system may assign a different weighting factor for different sources of sustainable energy utilization in the received verification data, although the system can assign a single weighting factor for all sustainable energy sources in other examples. For example, the system may assign a higher weighting factor if the sustainable energy is from a solar panel meter reading, and a lower weighting factor if from a wind turbine. In some embodiments, the system can dynamically adjust the weighting factor on a sliding scale for different sources of sustainable energy.

In block 350, the system (e.g., issuer system 102) may rank the user device (e.g., user device 104), based on the assigned weighting factor, against other user devices (e.g., additional user devices 104) which have provided the verification data. In some embodiments, the system may assign the weighting factor for the determined portion of the sustainable energy, and may determine a numeric value. Further, the system may use the numeric value assigned to the user device, and compare it against the numeric value determined for other user devices. In one example, the lowest numeric value can correspond to a higher-ranked user device. In another example, the highest numeric value can correspond to a higher-ranked user device.

In block 355, the system (e.g., issuer system 102) may identify a threshold rank for the user devices that have been ranked, as discussed above. In some embodiments, the threshold rank can depend alone, or in a combination with the total number of user devices that have been ranked, the weighting factor, the numeric value, or combinations thereof. In some embodiments, other parameters can also be used to determine the threshold rank. In one example, the threshold rank can be static, but in another example, the threshold rank can be dynamically adjusted. Further, the system can provide one or more incentives for the user devices above the threshold rank. In some embodiments, the system can provide the one or more incentives for the user devices below the threshold rank. In some embodiments, the incentives can relate to tokenized reward points that are provided to the user devices for use in completing a transaction. In some embodiments, these incentives can be redeemed as rewards with the system.

Referring again to the system environment 100 described in FIG. 1, the issuer system 102 can include one or more processors 112, a memory 114, and data storage, for example in database 120. The processor(s) 112 can include one or more of a microprocessor, microcontroller, digital signal processor, co-processor, or the like, or combinations thereof capable of executing stored instructions and operating upon stored data.

The memory 114 of the issuer system 102 can include, in some implementations, one or more suitable types of memory (e.g., volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and/or other applications, as necessary), executable instructions, and data.

The memory 114 of the issuer system 102 can contain an operating system (“OS”) 116 that can run one or more programs 118. The one or more programs 118 can perform one or more functions of the disclosed examples. The one or more programs 118 can include, for example, a program for accessing off-chain data and allocating pair values to the tokenized rewards and tokenized points. The memory 114 can also include any combination of one or more databases, including, for example, database 120, controlled by memory controller devices (e.g., server(s), etc.) or software, such as document management systems, Microsoft® SQL databases, SharePoint® databases, Oracle® databases, Sybase® databases, or other relational databases.

The issuer system 102 can include a communication interface 122 for communicating with external systems or internal systems. The communication interface 122 can include a serial port, a parallel port, a general-purpose input and output (GPIO) port, a game port, a universal serial bus (USB), a micro-USB port, a high definition multimedia (HDMI) port, a video port, an audio port, a Bluetooth™ port, an NFC port, another like communication interface, or any combination thereof. The communication interface 122 can include a transceiver 124 to communicate with compatible devices, for example, via short range, long range (e.g., cellular, local area networks (LAN), wide area networks (WAN), etc.), or similar technologies that enable the issuer system 102 to communicate via the network 110, as described herein.

The transaction system 106 can include one or more of the same or similar components as described for the issuer system 102. For example, the transaction system 106 can include a processor 132, memory 134, an OS 136, one or more programs 138, and data storage via a database 140, which can be the same as or similar to processor 112, memory 114, OS 116, program 118, and database 120, respectively. Further, the transaction system 106 can include a PoS device 130. The PoS device 130 can be an electronic funds transfer terminal that accepts payments via a credit card via a magnetic stripe and/or via contactless payment. The PoS device 130 can also include a backend system that receives transaction requests from a customer and transfers information to the issuer system 102.

While the present disclosure has been described in connection with a plurality of exemplary aspects, as illustrated in the various figures and discussed above, it is understood that other similar aspects can be used, or modifications and additions can be made, to the described aspects for performing the same function of the present disclosure without deviating therefrom. For example, in various aspects of the disclosure, methods and compositions were described according to aspects of the presently disclosed subject matter. However, other equivalent methods or composition to these described aspects are also contemplated by the teachings herein. Therefore, the present disclosure should not be limited to any single aspect, but rather construed in breadth and scope in accordance with the appended claims.

The components described in this disclosure as making up various elements of the systems and methods are intended to be illustrative and not restrictive. Many suitable components that would perform the same or similar functions as the components described herein are intended to be embraced within the scope of the disclosure. Such other components not described herein can include, but are not limited to, for example, similar components that are developed after development of the presently disclosed subject matter.

Examples of the present disclosure can be implemented according to at least the following clauses:

Clause 1: A system for providing an energy-efficient blockchain mining, the system comprising: one or more processors; and memory in communication with the one or more processors and storing instructions that, when executed by the one or more processors, are configured to cause the system to: receive a plurality of electronic utility data records associated with use of one or more utilities by one or more computing devices for mining blockchain; analyze each of the received plurality of electronic utility data records to determine when the received plurality of electronic utility data records is complete, wherein each of the received plurality of electronic utility data records is complete when each of the received plurality of electronic utility data records comprises a predefined set of utility measuring values; verify each of the analyzed plurality of electronic utility data records with a utility server to determine when each of the analyzed plurality of electronic utility data records is authentic upon determining that the received electronic utility data is complete, wherein the verifying further comprises: connect, via a network channel, with the utility server; identify an electronic record in the utility server associated with each of the analyzed plurality of electronic utility data records based on at least a unique identifying value in each of the analyzed plurality of electronic utility data records; and scan the identified electronic record for each of the analyzed plurality of electronic utility data records and correlate the identified electronic record with the analyzed plurality of electronic utility data records; assign a weighting factor for each of the verified plurality of electronic utility data records when the analyzed plurality of electronic utility data records is determined to be authentic; generate a sustainable energy score from the assigned weighting factor for each of the verified plurality of electronic utility data records; rank each of the verified plurality of electronic utility data records by the generated sustainable energy score; determine that one or more of the ranked plurality of electronic utility data records are above a predefined threshold level; and provide one or more incentives to the one or more computing devices associated with the determined one or more of the ranked plurality of electronic utility data records above the predefined threshold level.

Clause 2: The system of clause 1, wherein the instructions, when executed by the one or more processors, are further configured to cause the system to, determine a proportion of sustainable energy used in each of the verified plurality of electronic utility data records prior to ranking each of the verified plurality of electronic utility data records.

Clause 3: The system of clause 2, wherein the instructions, when executed by the one or more processors, are further configured to cause the system to, assigning a weighting factor only to the proportion of sustainable energy of each of the verified plurality of electronic utility data records prior to ranking each of the verified plurality of electronic utility data records.

Clause 4: The system of clause 1, wherein the instructions, when executed by the one or more processors, are further configured to cause the system to: periodically update the ranking each of the verified plurality of electronic utility data records; periodically determine the one or more of the ranked plurality of electronic utility data records that are above a predetermined threshold level upon periodically updating the ranking; and provide the one or more incentives to the one or more of the ranked plurality of electronic utility data records that are above the predefined threshold level upon periodically determining the one or more of the ranked plurality of electronic utility data records that are above a predetermined threshold level.

Clause 5: The system of clause 1, wherein the one or more incentives are associated with one or more mining rewards while performing mining of blockchain.

Clause 6: The system of clause 1, wherein, when executed by the one or more processors, are further configured to cause the system to, reject each of the analyzed plurality of electronic utility data records that is determined to be unauthentic without ranking and providing the one or more incentives.

Clause 7: A method for providing an energy-efficient blockchain mining, the method comprising: receiving, by one or more processors associated with an issuer system, a plurality of electronic utility data records associated with use of one or more utilities by one or more computing devices for mining blockchain; analyzing, by the one or more processors, each of the received plurality of electronic utility data records to determine when the received plurality of electronic utility data records is complete, wherein each of the received plurality of electronic utility data records is complete when each of the received plurality of electronic utility data records comprises a predefined set of utility measuring values; verifying, by the one or more processors, each of the analyzed plurality of electronic utility data records with a utility server to determine when each of the analyzed plurality of electronic utility data records is authentic upon determining that the received electronic utility data is complete, wherein the verifying further comprises: connecting, via a network channel, with the utility server; identifying an electronic record in the utility server associated with each of the analyzed plurality of electronic utility data records based on at least a unique identifying value in each of the analyzed plurality of electronic utility data records; and scanning the identified electronic record for each of the analyzed plurality of electronic utility data records and correlating the identified electronic record with the analyzed plurality of electronic utility data records; assigning, by the one or more processors, a weighting factor for each of the verified plurality of electronic utility data records when the analyzed plurality of electronic utility data records is determined to be authentic; generating, by the one or more processors, a sustainable energy score from the assigned weighting factor for each of the verified plurality of electronic utility data records; ranking, by the one or more processors, each of the verified plurality of electronic utility data records by the generated sustainable energy score; determining, by the one or more processors, one or more of the ranked plurality of electronic utility data records above a predefined threshold level; and providing, by the one or more processors, one or more incentives to the one or more computing devices associated with the determined one or more of the ranked plurality of electronic utility data records above the predefined threshold level.

Clause 8: The method of clause 7, further comprising, determining, by the one or more processors, a proportion of sustainable energy used in each of the verified plurality of electronic utility data records prior to ranking each of the verified plurality of electronic utility data records.

Clause 9: The method of clause 8, further comprising, assigning, by the one or more processors, a weighting factor only to the proportion of sustainable energy of each of the verified plurality of electronic utility data records prior to ranking each of the verified plurality of electronic utility data records.

Clause 10: The method of clause 7, further comprising: periodically updating, by the one or more processors, the ranking each of the verified plurality of electronic utility data records; periodically determining, by the one or more processors, the one or more of the ranked plurality of electronic utility data records that are above a predetermined threshold level upon periodically updating the ranking; and providing, by the one or more processors, the one or more incentives to the one or more of the ranked plurality of electronic utility data records that are above the predefined threshold level upon periodically determining the one or more of the ranked plurality of electronic utility data records that are above a predetermined threshold level.

Clause 11: The method of clause 7, wherein the one or more incentives are associated with one or more mining rewards while performing mining of blockchain.

Clause 12: The method of clause 7, further comprising, rejecting, by the one or more processors, each of the analyzed plurality of electronic utility data records that is determined to be unauthentic without ranking and providing the one or more incentives.

Clause 13: A method for providing an energy-efficient blockchain mining, the method comprising: verifying, by one or more processors associated with an issuer system, a plurality of received electronic utility data records with a utility server in real-time to determine when each of the plurality of received electronic utility data records is authentic, wherein the plurality of received electronic utility data records are associated with use of one or more utilities by one or more computing devices for mining blockchain; determining, by the one or more processors, a proportion of sustainable energy utilization data in each of the verified plurality of electronic utility data records determined to be authentic; assigning, by the one or more processors, a weighting factor to the determined proportion of the sustainable energy utilization data for each of the verified plurality of electronic utility data records determined to be authentic; generating, by the one or more processors, a sustainable energy score from the assigned weighting factor for each of the verified plurality of electronic utility data records; ranking, by the one or more processors, each of the verified plurality of electronic utility data records by the generated sustainable energy score; determining, by the one or more processors, one or more of the ranked plurality of electronic utility data records above a predefined threshold level; and providing, by the one or more processors, one or more incentives to the one or more computing devices associated with the determined one or more of the ranked plurality of electronic utility data records above the predefined threshold level.

Clause 14: The method of clause 13, further comprising, receiving, by one or more processors associated with the issuer system, the plurality of electronic utility data records associated with use of the one or more utilities by the one or more computing devices for mining blockchain.

Clause 15: The method of clause 14, further comprising, analyzing, by the one or more processors, each of the received plurality of electronic utility data records to determine when the received plurality of electronic utility data records is complete, wherein each of the received plurality of electronic utility data records is complete when each of the received plurality of electronic utility data records comprises a predefined set of utility measuring values.

Clause 16: The method of clause 13, wherein the verifying further comprises: connecting, by the one or more processors, via a network channel, with the utility server; identifying, by the one or more processors, an electronic record in the utility server associated with each of the analyzed plurality of electronic utility data records based on at least unique identifying value in each of the analyzed plurality of electronic utility data records; and scanning, by the one or more processors, the identified electronic record for each of the analyzed plurality of electronic utility data records and correlate identified electronic record with the analyzed plurality of electronic utility data records.

Clause 17: The method of clause 13, further comprising: periodically updating, by the one or more processors, the ranking each of the verified plurality of electronic utility data records; periodically determining, by the one or more processors, the one or more of the ranked plurality of electronic utility data records above a predefined threshold level upon periodically updating the ranking; and providing, by the one or more processors, the one or more incentives to the one or more of the ranked plurality of electronic utility data records that are above the predefined threshold level upon periodically determining the one or more of the ranked plurality of electronic utility data records that are above a predetermined threshold level.

Clause 18: The method of clause 13, wherein the one or more incentives are associated with one or more mining rewards while performing mining of blockchain.

Clause 19: The method of clause 13, further comprising, rejecting, by the one or more processors, each of the received plurality of electronic utility data records that is determined to be unauthentic without ranking and providing the one or more incentives.

Clause 20: The method of clause 13, wherein the weighting factor is assigned to the determined proportion of the sustainable energy utilization data for each the verified plurality of electronic utility data records when a new block is to be verified in a blockchain.

### Exemplary Use Case

The following exemplary use case describes an example of a typical user flow pattern. It is intended solely for explanatory purposes and not limitation. In one exemplary embodiment, the user device 104 provides the issuer system 102 with a utility bill where energy was consumed for the purpose of mining blockchain. The issuer system 102 scans the submitted utility bill to check if the data in the utility bill is complete. When the utility bill is complete, the issuer system 102 creates an oracle that connects with a vendor system 108 (a server of the utility company) to retrieve the record that is associated with the utility bill that was received. Further, the issuer system 102 scans the retrieved record and compares it with the utility bill that was received. When the issuer system 102 determines that the retrieved record exactly matches the received utility bill, the issuer system 102 determines a proportion of the sustainable energy that is used in the received utility bill. For the determined portion, the issuer system 102 assigns a weighting factor and determines a numeric value. With the numeric value, the issuer system 102 ranks the user device 104 against other user devices that have submitted the utility bill for mining of blockchain. Further, the issuer system 102 determines a threshold rank for the entire list of user devices that have submitted the utility bill for mining blockchain, and provides incentives or rewards to the user devices that fall above the threshold rank.

1. A system for providing an energy-efficient blockchain mining, the system comprising:
one or more processors; and
memory in communication with the one or more processors and storing instructions that, when executed by the one or more processors, are configured to cause the system to:
receive a plurality of electronic utility data records associated with use of one or more utilities by one or more computing devices for mining blockchain;
analyze each of the received plurality of electronic utility data records to determine when the received plurality of electronic utility data records is complete, wherein each of the received plurality of electronic utility data records is complete when each of the received plurality of electronic utility data records comprises a predefined set of utility measuring values;
responsive to determining the received plurality of electronic utility data records is not complete, create an oracle that connects with a utility server to retrieve energy data to compare against the electronic utility data records to determine proof of using sustainable energy;
verify each of the analyzed plurality of electronic utility data records with the utility server to determine when each of the analyzed plurality of electronic utility data records is authentic upon determining that the received electronic utility data is complete, wherein the verifying further comprises:
connect, via a network channel, with the utility server;
identify an electronic record in the utility server associated with each of the analyzed plurality of electronic utility data records based on at least a unique identifying value in each of the analyzed plurality of electronic utility data records; and
scan the identified electronic record for each of the analyzed plurality of electronic utility data records and correlate the identified electronic record with the analyzed plurality of electronic utility data records;
assign a weighting factor for each of the verified plurality of electronic utility data records when the analyzed plurality of electronic utility data records is determined to be authentic;
generate a sustainable energy score from the assigned weighting factor for each of the verified plurality of electronic utility data records;
rank each of the verified plurality of electronic utility data records by the generated sustainable energy score;
determine that one or more of the ranked plurality of electronic utility data records are above a predefined threshold level;
provide one or more incentives to the one or more computing devices associated with the determined one or more of the ranked plurality of electronic utility data records above the predefined threshold level; and
dynamically adjusting the predefined threshold level based on the weighting factor and the one or more computing devices.

2. The system of claim 1, wherein the instructions, when executed by the one or more processors, are further configured to cause the system to, determine a proportion of sustainable energy used in each of the verified plurality of electronic utility data records prior to ranking each of the verified plurality of electronic utility data records.

3. The system of claim 2, wherein the instructions, when executed by the one or more processors, are further configured to cause the system to, assigning a weighting factor only to the proportion of sustainable energy of each of the verified plurality of electronic utility data records prior to ranking each of the verified plurality of electronic utility data records.

4. The system of claim 1, wherein the instructions, when executed by the one or more processors, are further configured to cause the system to:
periodically update the ranking each of the verified plurality of electronic utility data records;
periodically determine the one or more of the ranked plurality of electronic utility data records that are above a predetermined threshold level upon periodically updating the ranking; and
provide the one or more incentives to the one or more of the ranked plurality of electronic utility data records that are above the predefined threshold level upon periodically determining the one or more of the ranked plurality of electronic utility data records that are above a predetermined threshold level.

5. The system of claim 1, wherein the one or more incentives are associated with one or more mining rewards while performing mining of blockchain.

6. The system of claim 1, wherein, when executed by the one or more processors, are further configured to cause the system to, reject each of the analyzed plurality of electronic utility data records that is determined to be unauthentic without ranking and providing the one or more incentives.

7. A method for providing an energy-efficient blockchain mining, the method comprising:
receiving, by one or more processors associated with an issuer system, a plurality of electronic utility data records associated with use of one or more utilities by one or more computing devices for mining blockchain;
analyzing, by the one or more processors, each of the received plurality of electronic utility data records to determine when the received plurality of electronic utility data records is complete, wherein each of the received plurality of electronic utility data records is complete when each of the received plurality of electronic utility data records comprises a predefined set of utility measuring values;
responsive to determining the received plurality of electronic utility data records is not complete, creating an oracle that connects with a utility server to retrieve energy data to compare against the electronic utility data records to determine proof of using sustainable energy;
verifying, by the one or more processors, each of the analyzed plurality of electronic utility data records with the utility server to determine when each of the analyzed plurality of electronic utility data records is authentic upon determining that the received electronic utility data is complete, wherein the verifying further comprises:
connecting, via a network channel, with the utility server;
identifying an electronic record in the utility server associated with each of the analyzed plurality of electronic utility data records based on at least a unique identifying value in each of the analyzed plurality of electronic utility data records; and
scanning the identified electronic record for each of the analyzed plurality of electronic utility data records and correlating the identified electronic record with the analyzed plurality of electronic utility data records;
assigning, by the one or more processors, a weighting factor for each of the verified plurality of electronic utility data records when the analyzed plurality of electronic utility data records is determined to be authentic;
generating, by the one or more processors, a sustainable energy score from the assigned weighting factor for each of the verified plurality of electronic utility data records;
ranking, by the one or more processors, each of the verified plurality of electronic utility data records by the generated sustainable energy score;
determining, by the one or more processors, one or more of the ranked plurality of electronic utility data records above a predefined threshold level;
providing, by the one or more processors, one or more incentives to the one or more computing devices associated with the determined one or more of the ranked plurality of electronic utility data records above the predefined threshold level; and
dynamically adjusting the predefined threshold level based on the weighting factor and the one or more computing devices.

8. The method of claim 7, further comprising, determining, by the one or more processors, a proportion of sustainable energy used in each of the verified plurality of electronic utility data records prior to ranking each of the verified plurality of electronic utility data records.

9. The method of claim 8, further comprising, assigning, by the one or more processors, a weighting factor only to the proportion of sustainable energy of each of the verified plurality of electronic utility data records prior to ranking each of the verified plurality of electronic utility data records.

10. The method of claim 7, further comprising:
periodically updating, by the one or more processors, the ranking each of the verified plurality of electronic utility data records;
periodically determining, by the one or more processors, the one or more of the ranked plurality of electronic utility data records that are above a predetermined threshold level upon periodically updating the ranking; and
providing, by the one or more processors, the one or more incentives to the one or more of the ranked plurality of electronic utility data records that are above the predefined threshold level upon periodically determining the one or more of the ranked plurality of electronic utility data records that are above a predetermined threshold level.

11. The method of claim 7, wherein the one or more incentives are associated with one or more mining rewards while performing mining of blockchain.

12. The method of claim 7, further comprising, rejecting, by the one or more processors, each of the analyzed plurality of electronic utility data records that is determined to be unauthentic without ranking and providing the one or more incentives.

13. A method for providing an energy-efficient blockchain mining, the method comprising:
creating an oracle that connects with a utility server to retrieve energy data to compare against a plurality of received electronic utility data records to determine proof of using sustainable energy;
verifying, by one or more processors associated with an issuer system, the plurality of received electronic utility data records with the utility server in real-time to determine when each of the plurality of received electronic utility data records is authentic, wherein the plurality of received electronic utility data records are associated with use of one or more utilities by one or more computing devices for mining blockchain;
determining, by the one or more processors, a proportion of sustainable energy utilization data in each of the verified plurality of electronic utility data records determined to be authentic;
assigning, by the one or more processors, a weighting factor to the determined proportion of the sustainable energy utilization data for each of the verified plurality of electronic utility data records determined to be authentic;
generating, by the one or more processors, a sustainable energy score from the assigned weighting factor for each of the verified plurality of electronic utility data records;
ranking, by the one or more processors, each of the verified plurality of electronic utility data records by the generated sustainable energy score;
determining, by the one or more processors, one or more of the ranked plurality of electronic utility data records above a predefined threshold level;
providing, by the one or more processors, one or more incentives to the one or more computing devices associated with the determined one or more of the ranked plurality of electronic utility data records above the predefined threshold level; and
dynamically adjusting the predefined threshold level based on the weighting factor and the one or more computing devices.

14. The method of claim 13, further comprising, receiving, by one or more processors associated with the issuer system, the plurality of electronic utility data records associated with use of the one or more utilities by the one or more computing devices for mining blockchain.

15. The method of claim 14, further comprising, analyzing, by the one or more processors, each of the received plurality of electronic utility data records to determine when the received plurality of electronic utility data records is complete, wherein each of the received plurality of electronic utility data records is complete when each of the received plurality of electronic utility data records comprises a predefined set of utility measuring values.

16. The method of claim 13, wherein the verifying further comprises:
connecting, by the one or more processors, via a network channel, with the utility server;
identifying, by the one or more processors, an electronic record in the utility server associated with each of the analyzed plurality of electronic utility data records based on at least unique identifying value in each of the analyzed plurality of electronic utility data records; and
scanning, by the one or more processors, the identified electronic record for each of the analyzed plurality of electronic utility data records and correlate identified electronic record with the analyzed plurality of electronic utility data records.

17. The method of claim 13, further comprising:
periodically updating, by the one or more processors, the ranking each of the verified plurality of electronic utility data records;
periodically determining, by the one or more processors, the one or more of the ranked plurality of electronic utility data records above a predefined threshold level upon periodically updating the ranking; and
providing, by the one or more processors, the one or more incentives to the one or more of the ranked plurality of electronic utility data records that are above the predefined threshold level upon periodically determining the one or more of the ranked plurality of electronic utility data records that are above a predetermined threshold level.

18. The method of claim 13, wherein the one or more incentives are associated with one or more mining rewards while performing mining of blockchain.

19. The method of claim 13, further comprising, rejecting, by the one or more processors, each of the received plurality of electronic utility data records that is determined to be unauthentic without ranking and providing the one or more incentives.

20. The method of claim 13, wherein the weighting factor is assigned to the determined proportion of the sustainable energy utilization data for each the verified plurality of electronic utility data records when a new block is to be verified in a blockchain.
